(19) United States
(12) Patent Application Publication
(10) Pub. No.: US 2008/0005070 A1
(43) Pub. Date: Jan. 3, 2008

(54) Non-Repetitive Web Searching

(75) Inventor: Dale W. Malik, Dunwoody, GA (US)

Correspondence Address: THOMAS, KAYDEN, HORSTEMEYER & RISLEY, LLP/;AT&T BLS Intellectual Property, Inc., 600 GALLERIA PARKWAY, SUITE 1500, ATLANTA, GA, 30339, US

(73) Assignee: BellSouth Intellectual Property Corporation, Wilmington, DE (US)

(21) Appl. No.: 11/427,138

(22) Filed: Jun. 28, 2006

(51) Int. Cl. G06F 17/30

(52) U.S. Cl. 707/3

(57) ABSTRACT

Included are embodiments of a method for displaying search results. At least one embodiment of a method includes receiving search results related to a first requested search and requesting access to at least one of the received results. Other embodiments include storing data related to the requested at least one result, receiving search results related to a second requested search, and determining whether at least one of the search results related to the second requested search matches at least a portion of the stored data related to the requested at least one result. Still other embodiments include displaying a subset of the search results related to the second requested search.

### BACKGROUND

As Internet usage has increased, numerous websites have emerged to provide information, goods and services to Internet users. With the enormous number of web sites available, search engines have developed to provide users with tools to locate other websites according to a user's search criteria. While search engines may be configured to provide information related to the user's search criteria, there is often an exorbitant amount of data that may result from a particular search. As such, the user can oftentimes have difficulty finding a website that most matches the desired information, goods and/or services.

Thus, a heretofore unaddressed need exists in the industry to address the aforementioned deficiencies and inadequacies.

### SUMMARY

Included are embodiments of a method for displaying search results. At least one embodiment of a method includes receiving search results related to a first requested search and requesting access to at least one of the received results. Other embodiments include storing data related to the requested at least one result, receiving search results related to a second requested search, and determining whether at least one of the search results related to the second requested search matches at least a portion of the stored data related to the requested at least one result. Still other embodiments include displaying a subset of the search results related to the second requested search.

Also included are embodiments of a computer readable medium for displaying search results. At least one embodiment includes logic configured to receive search results related to a first requested search, logic configured to request access to at least one of the received results, and logic configured to store data related to the requested at least one result. Other embodiments include logic configured to receive search results related to a second requested search, logic configured to determine whether at least one of the search results related to the second requested search matches at least a portion of the stored data related to the requested at least one result, and logic configured to, in response to determining that at least one of the search results related to the second search matches at least a portion of the stored data related to the requested at least one result, display a subset of the search results related to the second requested search.

Additionally included are embodiments of a system for filtering search results. At least one embodiment includes a receiving module configured to receive a plurality of search results, a determination module configured to determine whether at least one of the results has been previously selected, and a display module configured to display the plurality of results without the at least one previously selected result.

Other systems, methods, features, and advantages of this disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

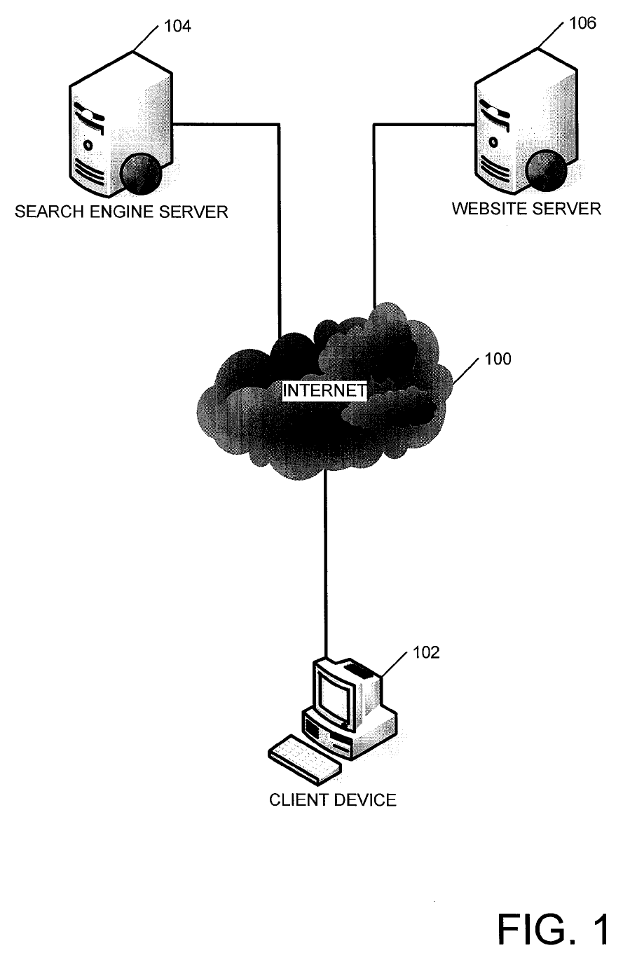

FIG. 1 is a network diagram illustrating exemplary components that may be implemented to provide a user with website data.

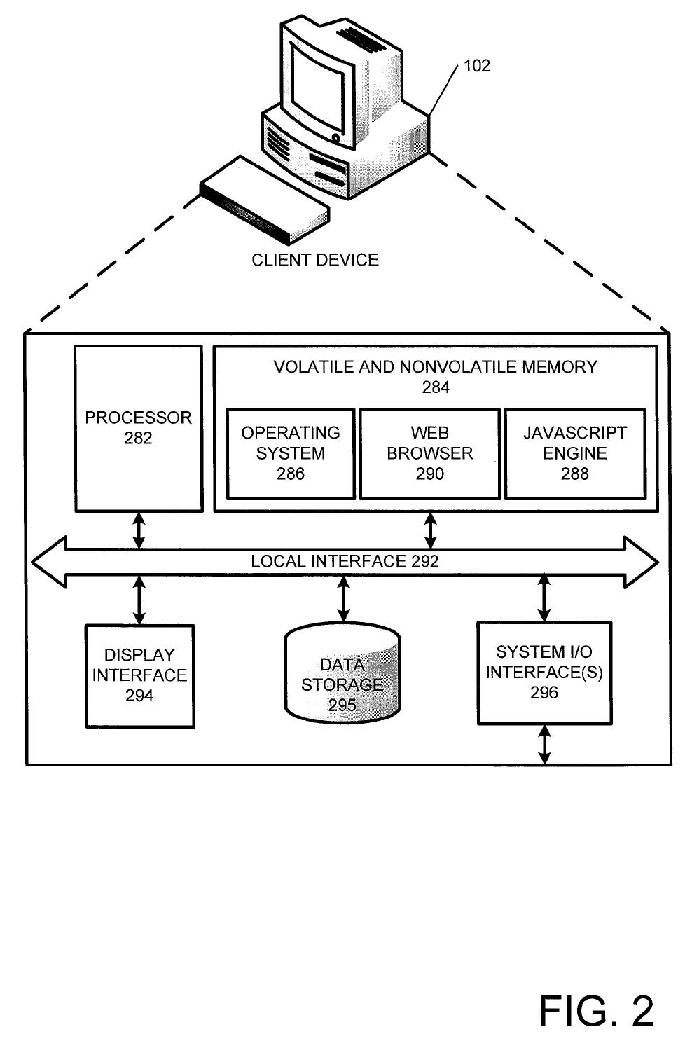

FIG. 2 is a block diagram illustrating exemplary components that may be associated with a client device, such as the client device from FIG. 1.

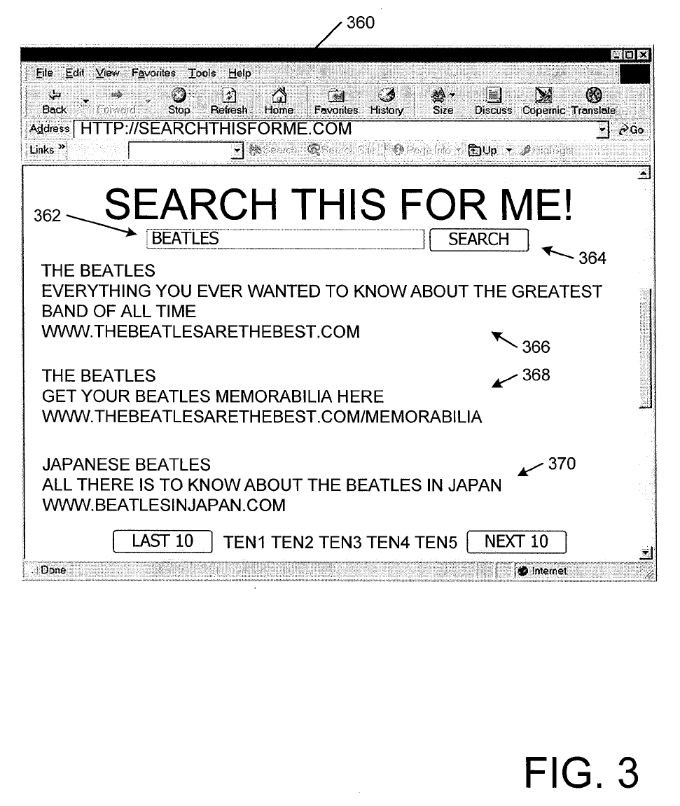

FIG. 3 is a screenshot diagram of an exemplary user interface, illustrating a search engine display that may be provided by the search engine server from FIG. 1.

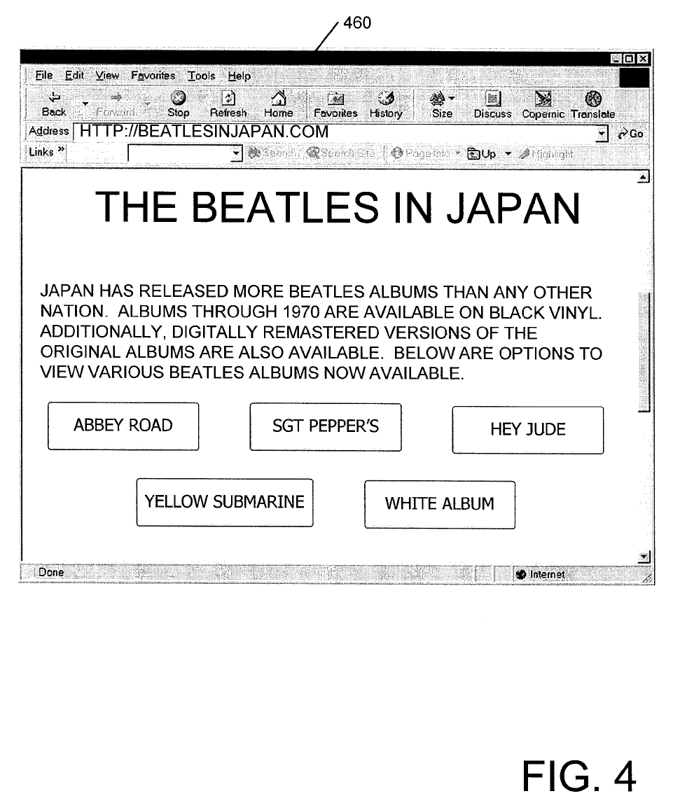

FIG. 4 is a screenshot diagram illustrating an exemplary user interface for a website that may be revealed by a search using the search engine display from FIG. 3.

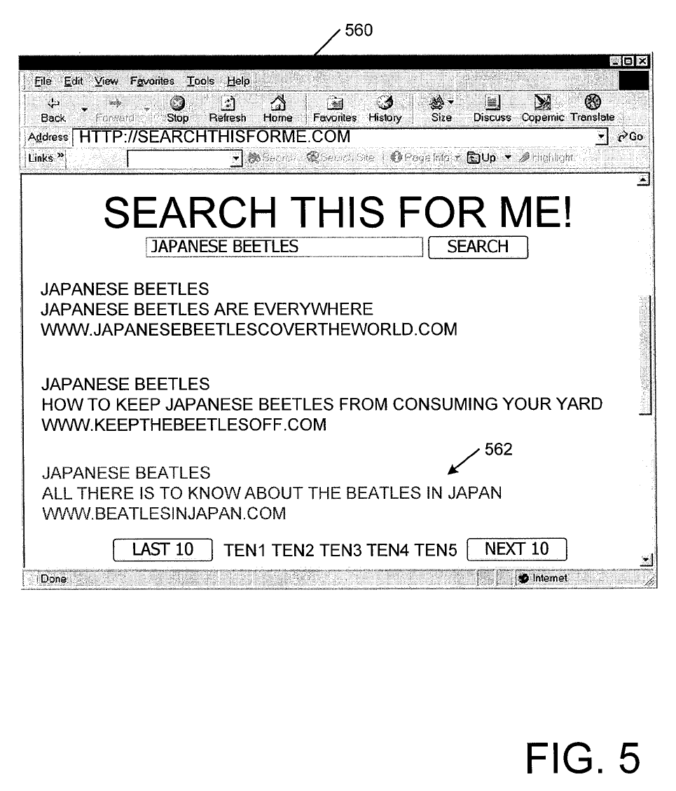

FIG. 5 is a screenshot diagram illustrating an exemplary user interface configured to display the search results from FIG. 3, further illustrating a previously selected result.

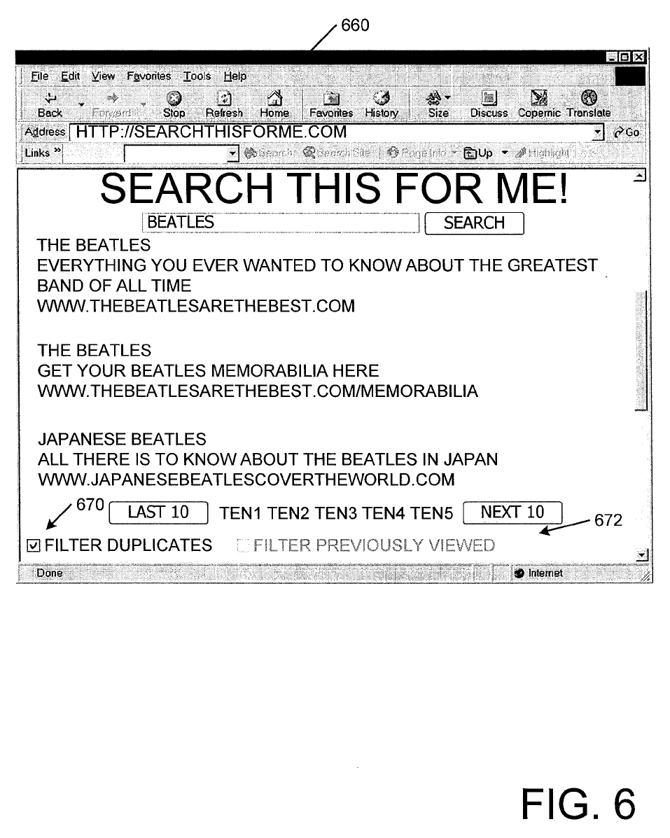

FIG. 6 is a screenshot diagram of an exemplary user interface, illustrating the search engine display from FIG. 3, further including filtering options.

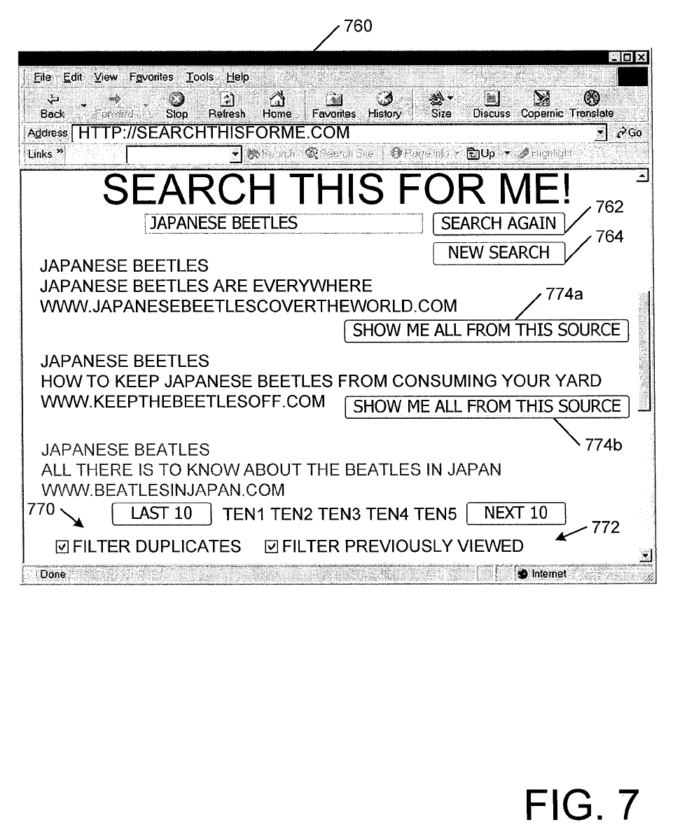

FIG. 7 is a screenshot diagram of an exemplary user interface associated with the search engine display from FIG. 3, further including a “search again” option.

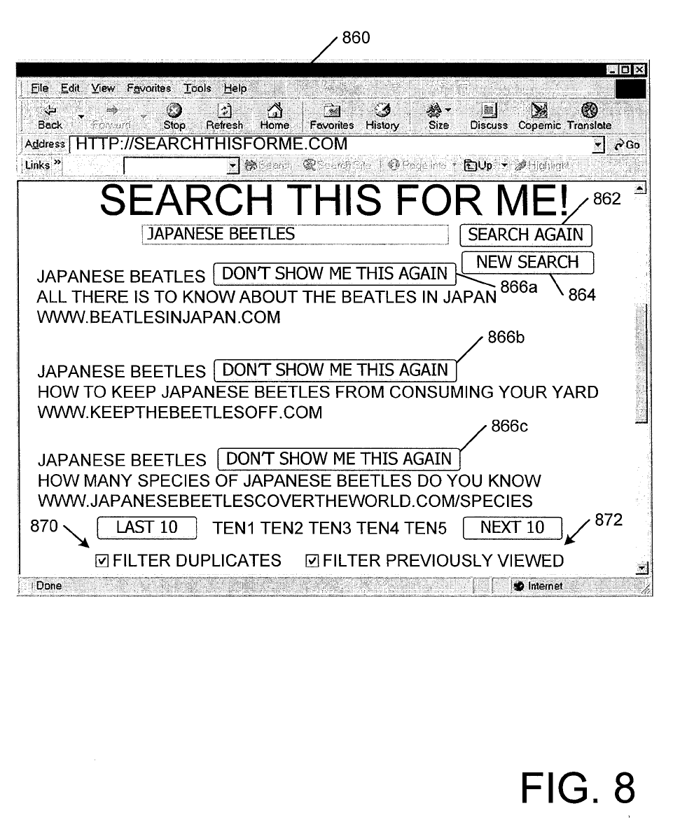

FIG. 8 is a screenshot diagram of an exemplary user interface, illustrating the search engine display from FIG. 3, further including a “don't show me this again” option.

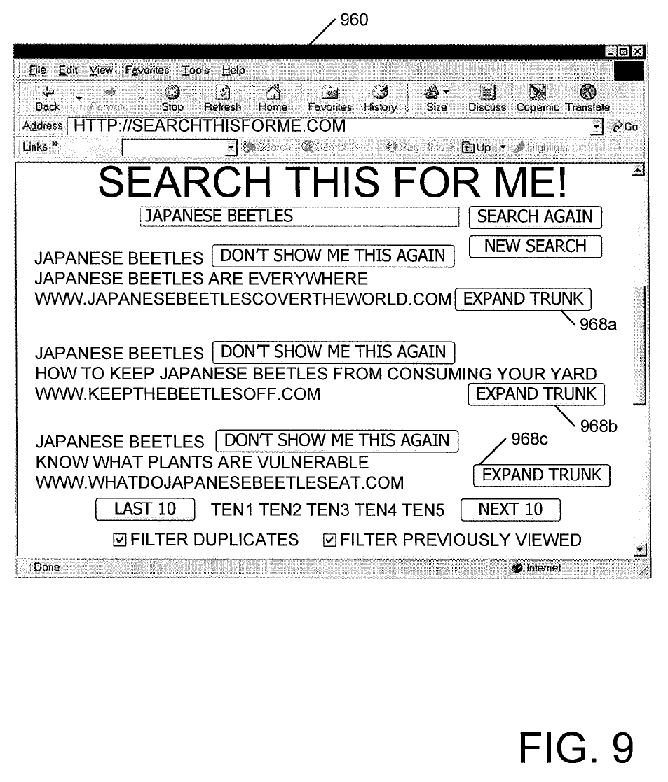

FIG. 9 is a screenshot diagram of an exemplary user interface, illustrating the search engine display from FIG. 3, further including a trunk expansion option.

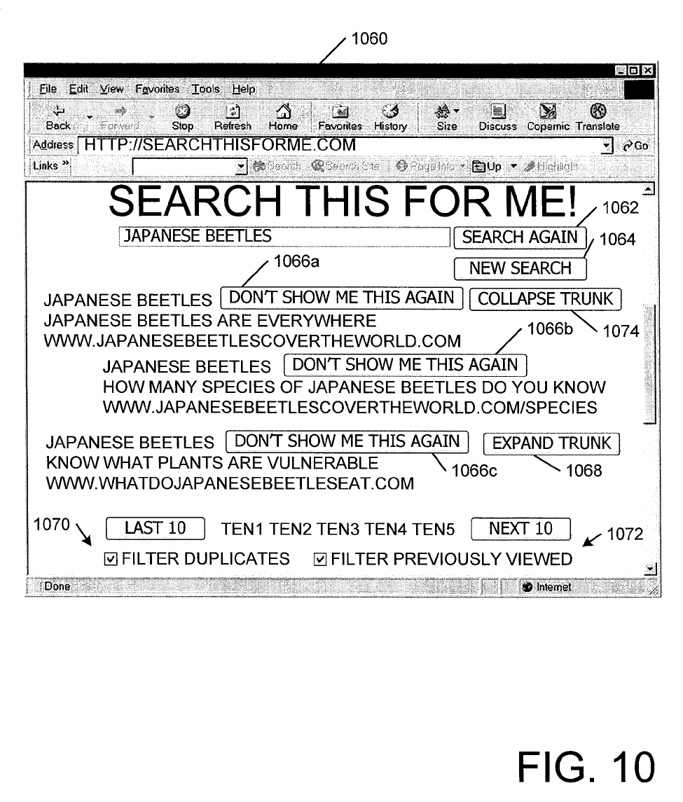

FIG. 10 is a screenshot diagram of an exemplary user interface, illustrating the search engine display from FIG. 3, further including a trunk collapse option.

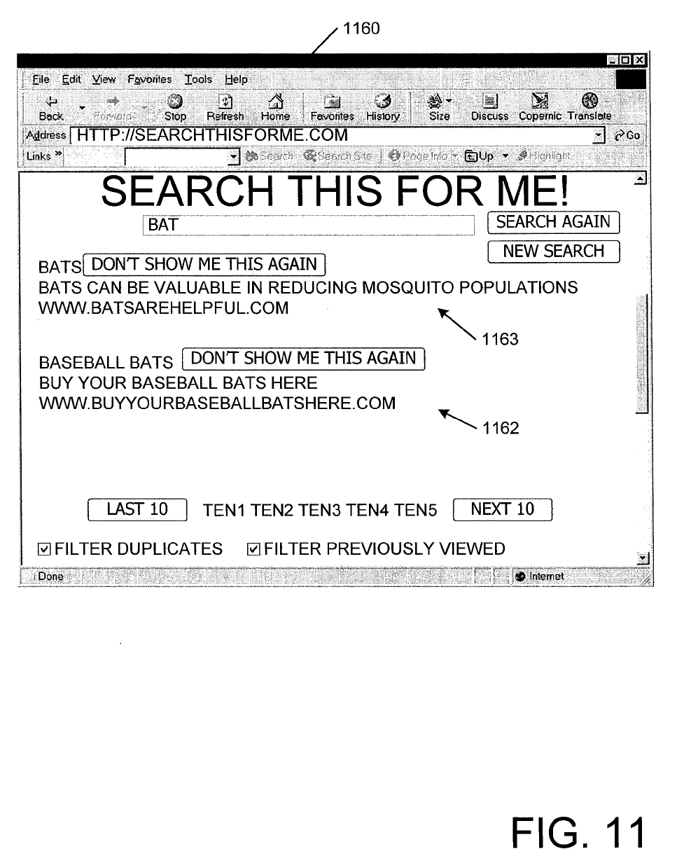

FIG. 11 is a screenshot diagram of an exemplary user interface, illustrating the search engine display from FIG. 3, further including an embodiment for utilization of a context based searching.

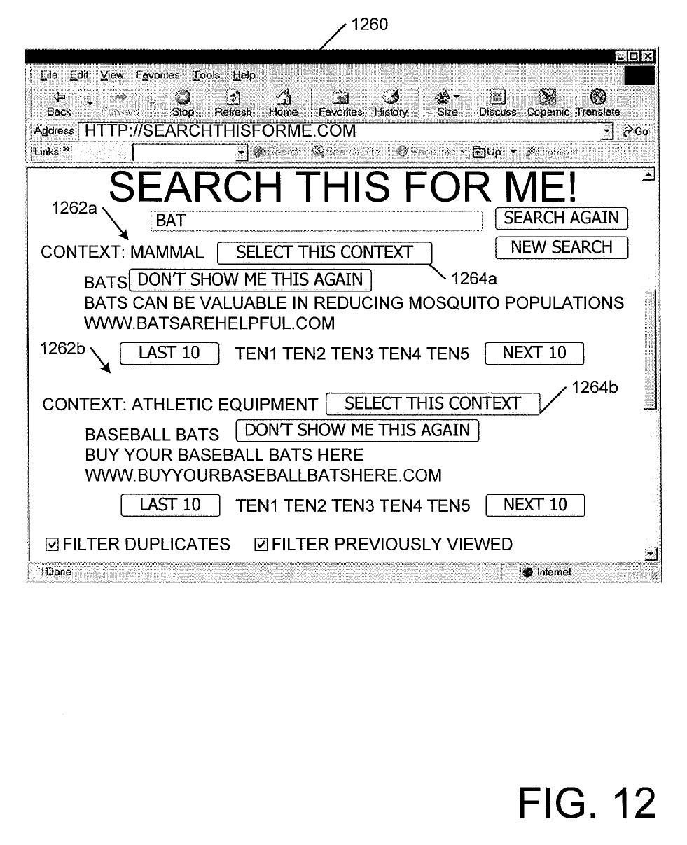

FIG. 12 is a screenshot diagram of an exemplary user interface illustrating the search engine display from FIG. 3, further including a user option to select from a plurality of contexts.

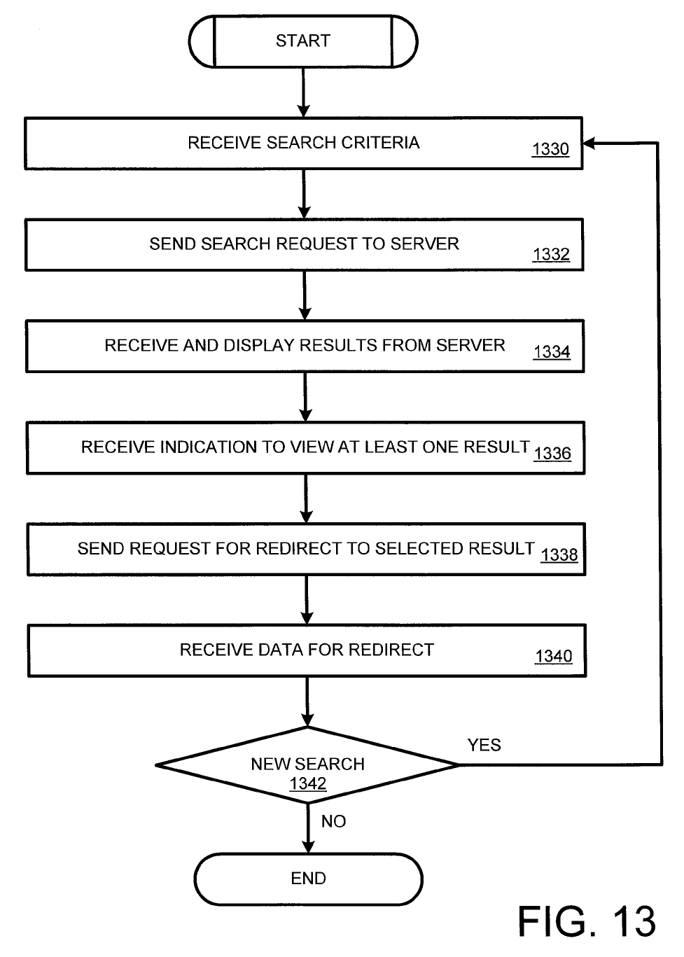

FIG. 13 is a flowchart illustrating exemplary steps that can be taken by a web browser in searching for web pages from the search engine display from FIG. 3.

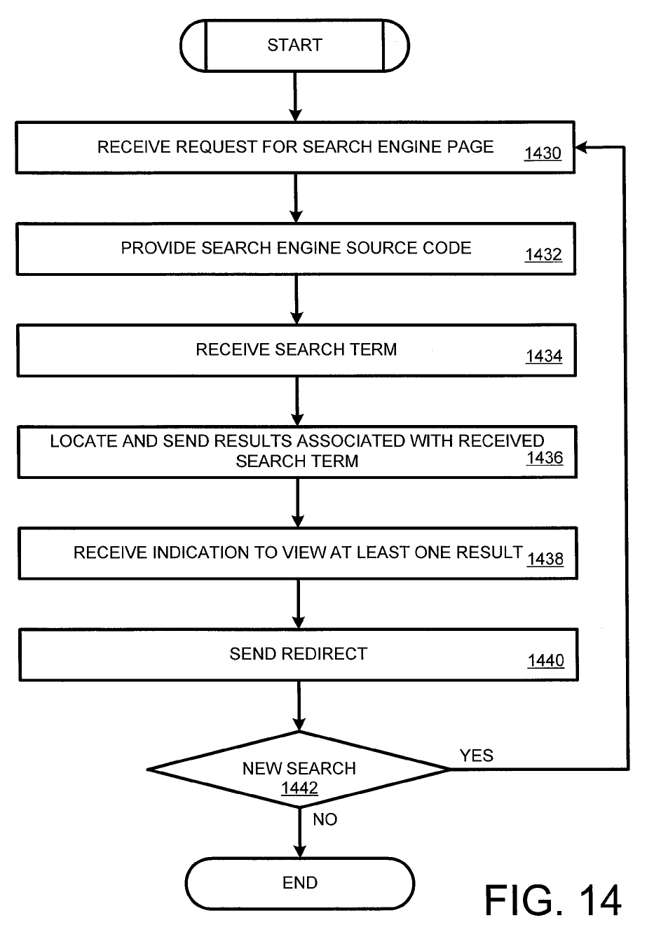

FIG. 14 is a flowchart illustrating exemplary steps that can be taken by a server, such as the server from FIG. 1, in searching for web pages.

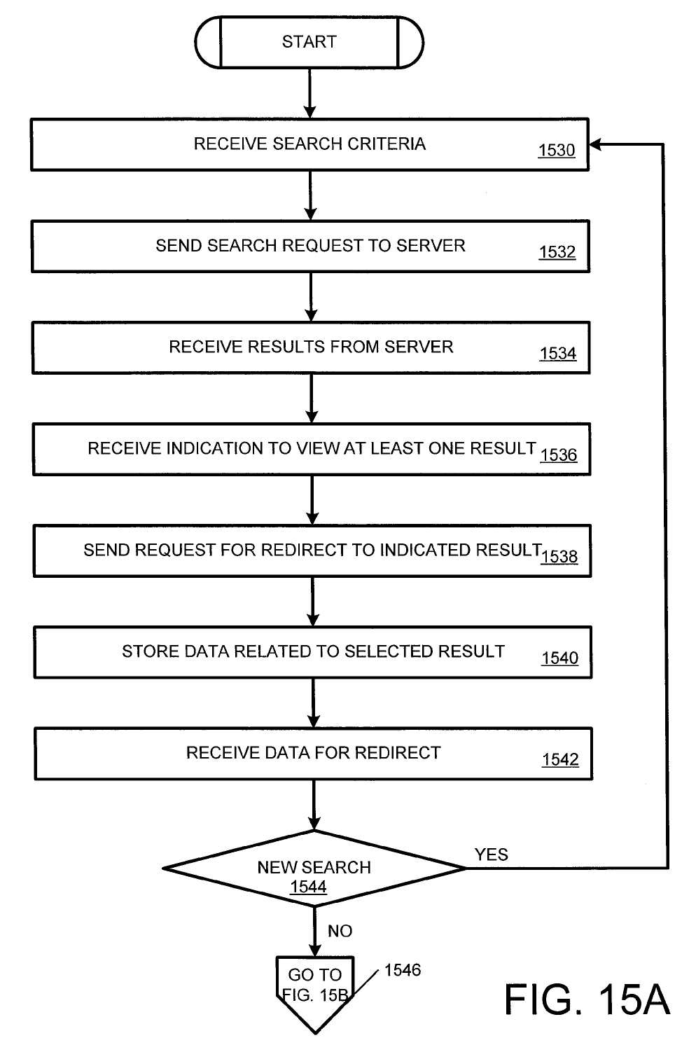

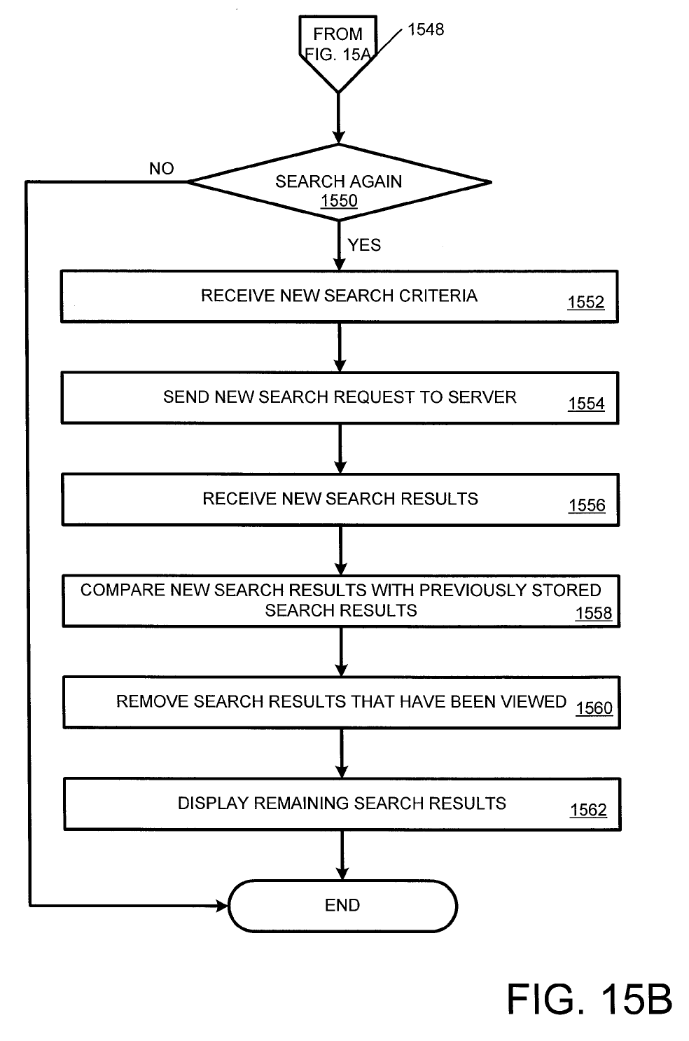

FIG. 15A is a flowchart illustrating exemplary steps that can be taken by a web browser in displaying unviewed search results, similar to the flowchart from FIG. 14.

FIG. 15B is a continuation of the flowchart from FIG. 15A.

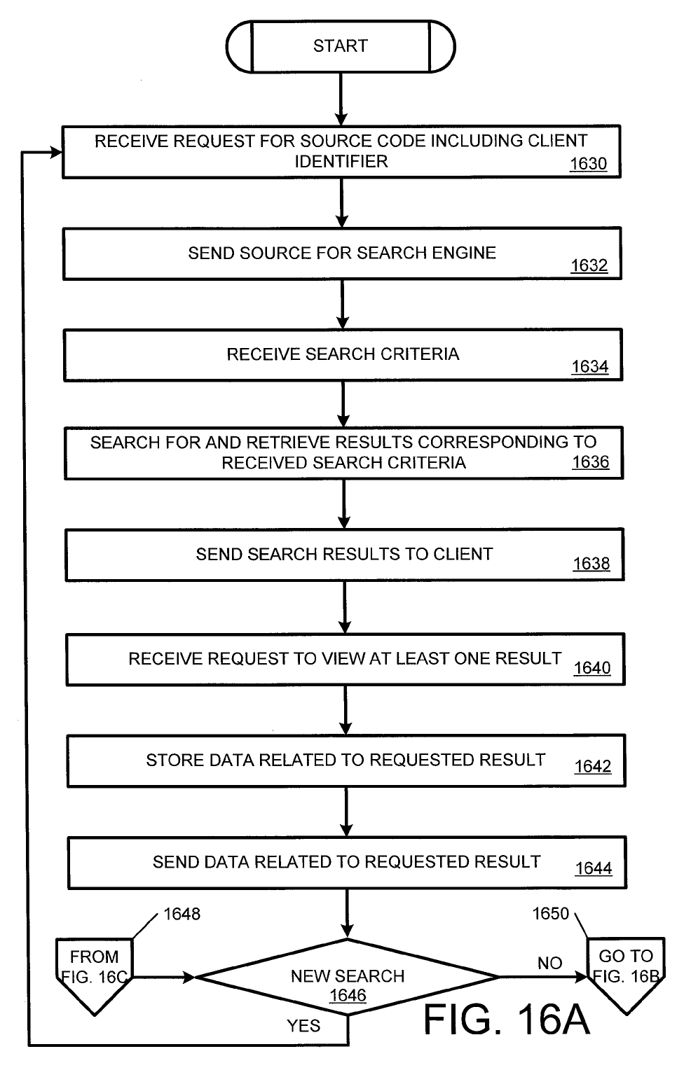

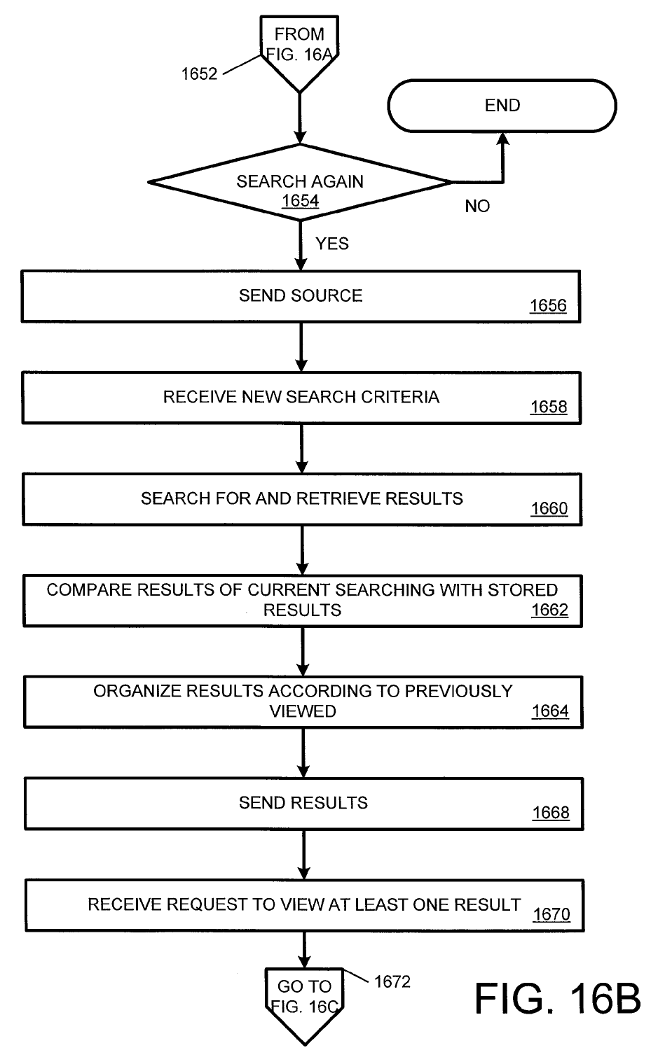

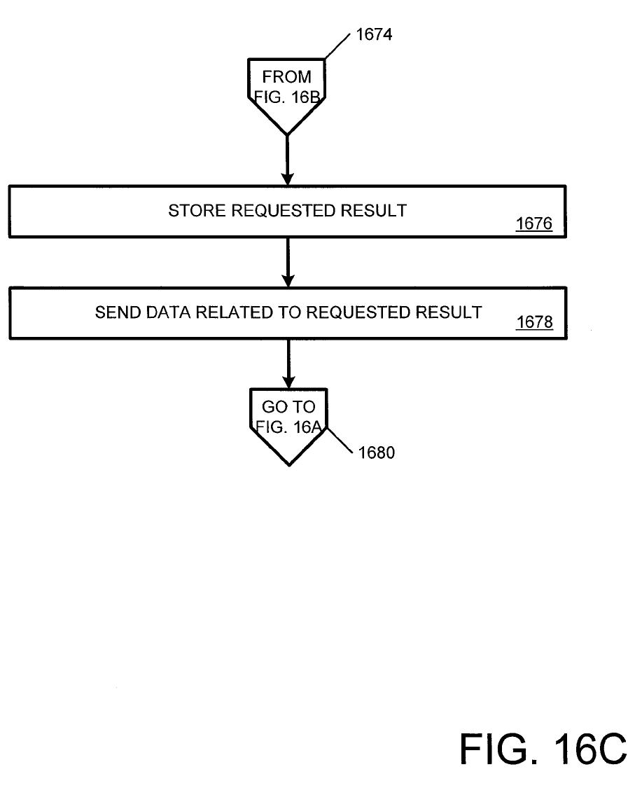

FIG. 16A is a flowchart illustrating exemplary steps that can be taken by a server in displaying unviewed results, similar to the flowcharts from FIGS. 15A and 15B.

FIG. 16B is a continuation of the flowchart from FIG. 16A.

FIG. 16C is a continuation of the flowchart from FIG. 16B.

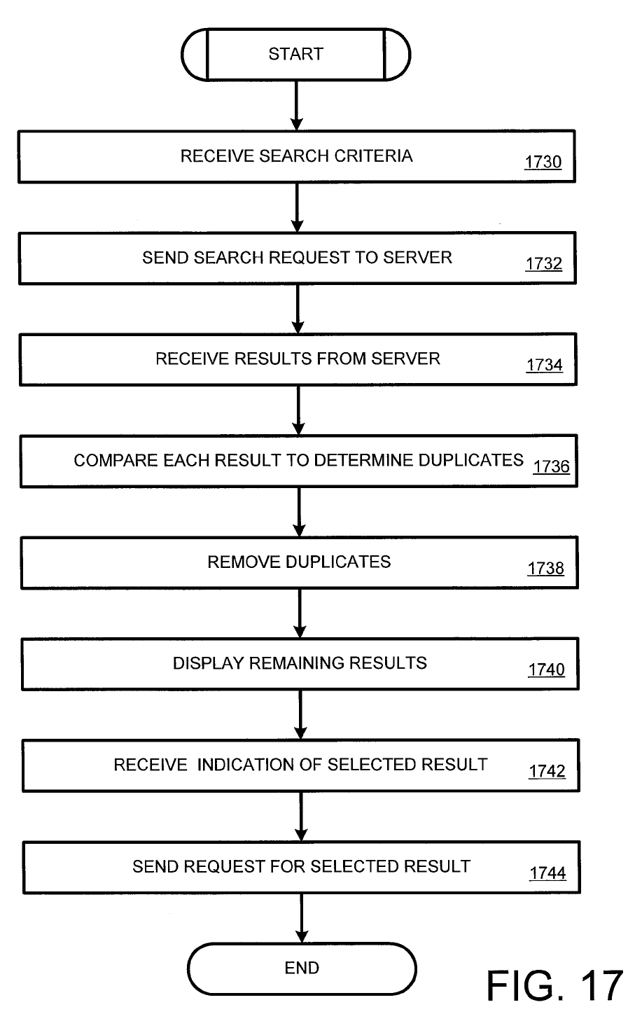

FIG. 17 is a flowchart illustrating exemplary steps that can be taken by a web browser in removing duplicate results from a search, similar to the flowchart from FIGS. 16A, 16B, and 16C.

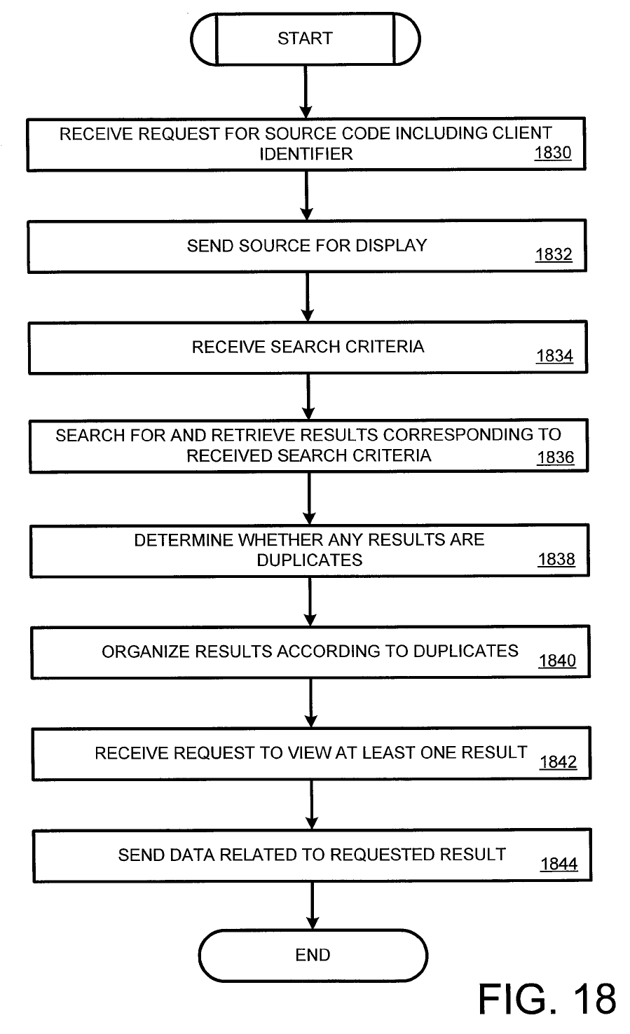

FIG. 18 is a flowchart illustrating exemplary steps that can be taken by a server in removing duplicate results from a search, similar to the flowchart from FIGS. 16A, 16B, and 16C.

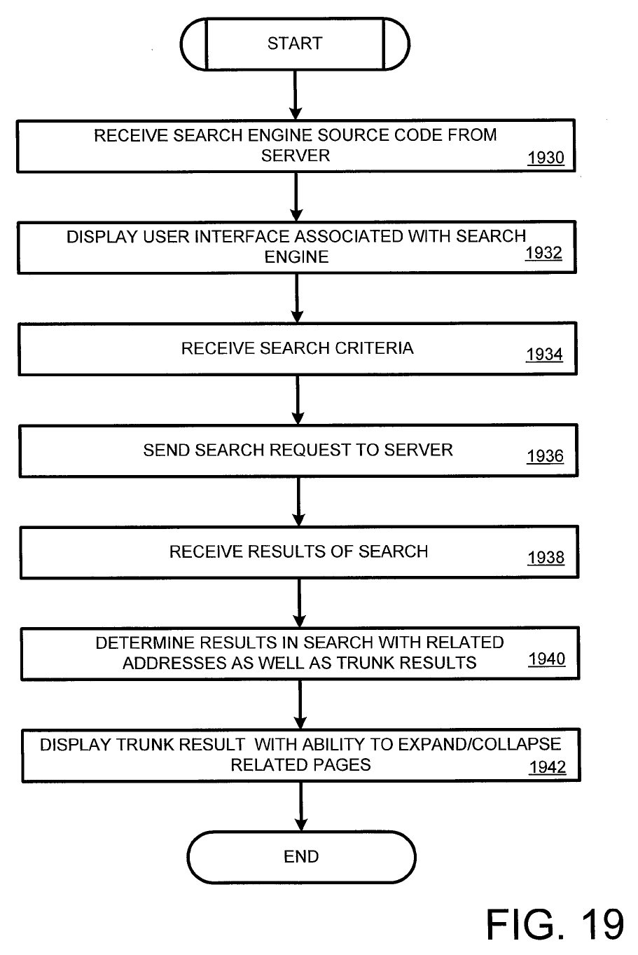

FIG. 19 is a flowchart illustrating exemplary steps that can be taken by a web browser in determining related results from a search, similar to the flowchart from FIG. 17.

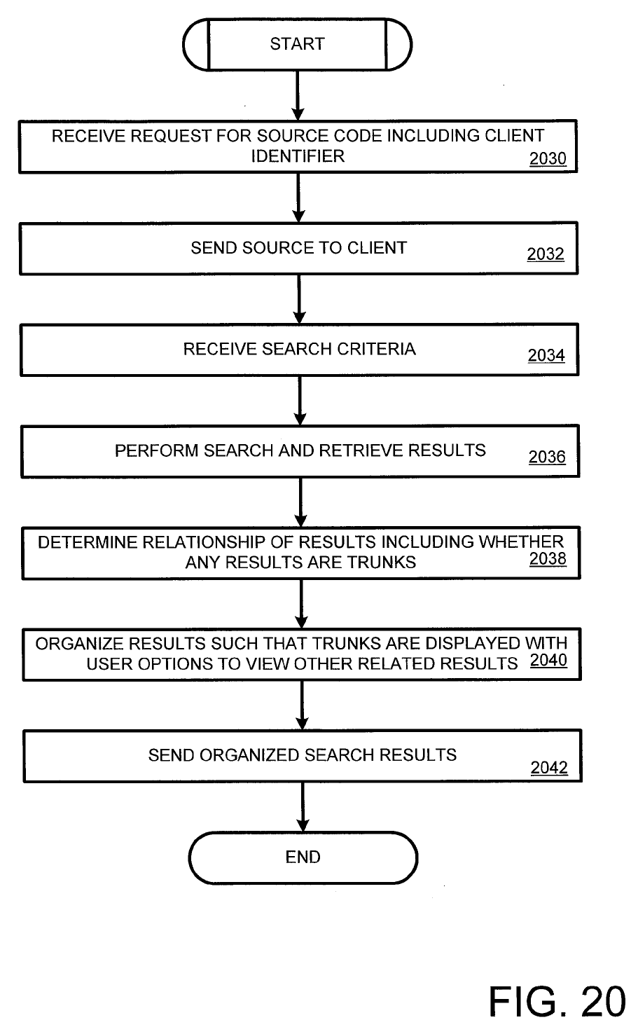

FIG. 20 is a flowchart illustrating exemplary steps that can be taken by a server in organizing related results, similar to the flowchart from FIG. 18.

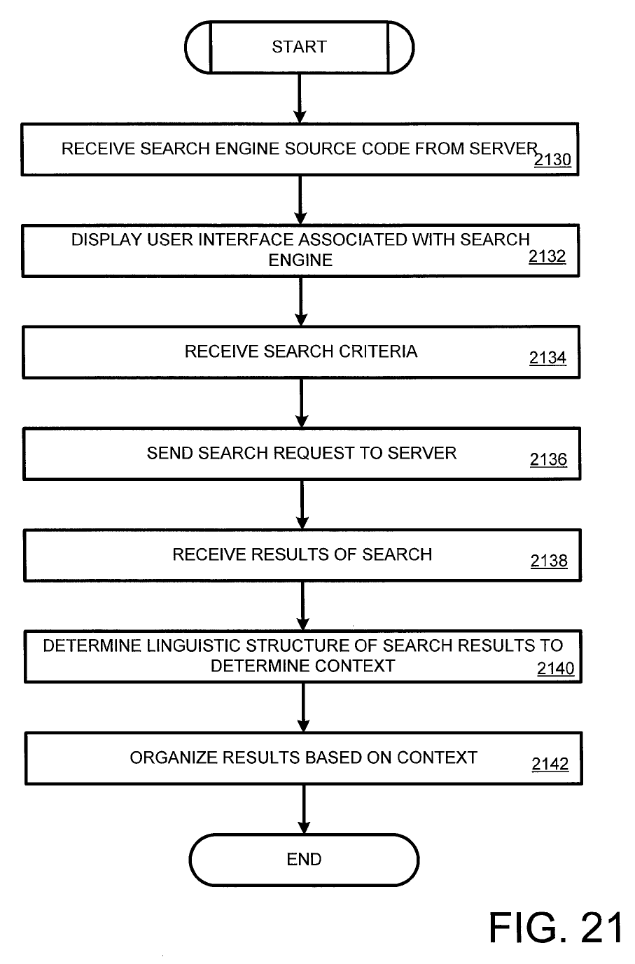

FIG. 21 is a flowchart illustrating exemplary steps that can be taken by a web browser in providing context based searching, similar to the flowchart from FIG. 19.

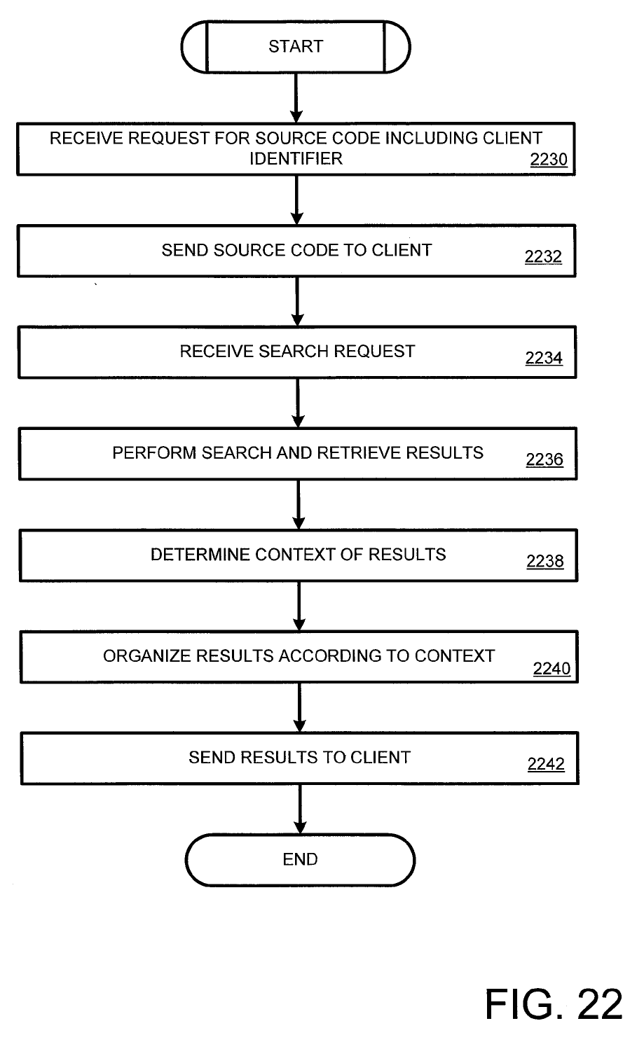

FIG. 22 is a flowchart illustrating exemplary steps that can be taken by a server in providing context based searching, similar to the flowchart from FIG. 21.

### DETAILED DESCRIPTION

FIG. 1 is a network diagram illustrating exemplary components that may be implemented to provide a user with website data. More specifically, the configuration from FIG. 1 illustrates a client device 102 coupled to a network, such at the Internet 100. The Internet 100 may also be coupled to a search engine server 104, as well as a website server 106. In operation, the client device 102 can access the Internet 100, which can act as a portal for data provided by search engine server 104. The search engine server 104 can provide data related to a web page that allows the user of client device 102 to enter search criteria related to desired subject matter. The search engine 104 server can then search other web pages associated with the Internet 100 according to the received search criteria. Upon completing the search, the search engine server 104 can provide data (which may take the form of source code) that includes an address associated with at least one of the web pages revealed in the search. Upon receiving the data, a web browser (and/or other logic) associated with the client device 102 can determine a format for displaying the received information. The user can then select at least one of the addresses. Upon receiving the user selection, the search engine server 104 can redirect the client device 102 to the website server 106 associated with the selected address.

One should note that although a single server is illustrated for representing search engine server 104, as one of ordinary skill on the art will understand, one or more servers, computers, etc. may be utilized to provide the desired functionality. Similarly, while the components of FIG. 1 are illustrated as having a wired connection to Internet 100, this is also a nonlimiting example. In at least one embodiment one or more component may be wirelessly coupled to Internet 100.

FIG. 2 is a block diagram illustrating exemplary components that may be associated with a client device, such as the client device from FIG. 1. Although the client device of FIG. 2 is illustrated as a personal computer, this discussion can be applied to any device that can be configured for providing the desired functionality. Examples include, but are not limited to a desktop computer, laptop computer, mobile telephone, Blackberry®, PDA, Ipod®, Treo®, etc. Generally, in terms of hardware architecture, as shown in FIG. 2, the client device 102 includes a processor 282, volatile and nonvolatile memory 284, a display interface 294, data storage 290, and one or more input and/or output (I/O) device interface(s) 296 that are communicatively coupled via a local interface 292. The local interface 292 can include one or more buses and/or other wired or wireless connections. The local interface 292 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 282 may be a hardware device for executing software, particularly software stored in volatile and nonvolatile memory 284.

The processor 282 can be any custom made or commercially available processor, a central processing unit (CPU), an auxiliary processor among several processors associated with the client device 102, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80×86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 284 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 284 may incorporate electronic, magnetic, optical, and/or other types of storage media. Note that the volatile and nonvolatile memory 284 can have a distributed architecture, where various components are situated remote from one another, but can be accessed by the processor 282. Additionally, volatile and nonvolatile memory 284 can include an operating system 286, a web browser 290, and a JavaScript engine 288. As one of ordinary skill in the art will understand, while the operating system 286, web browser 290, and JavaScript engine 288 are illustrated as separate software components within the same memory unit 284, this is a nonlimiting example. More specifically, depending on the particular configuration, these software components may be combined either in whole or in part. Similarly, while client device 102 is illustrated as including an operating system 286 a web browser 290, and a JavaScript engine 288, one should note that, depending on the particular configuration, client device 102 may include only a portion of these components and/or functionality. Additionally, while these components are illustrated as software modules, as one of ordinary skill in the art will understand, this logic can be represented in one or more components of software, hardware, firmware, etc.

Additionally, the operating system 286 in volatile and nonvolatile memory 284 may include one or more separate programs, each of which includes an ordered listing of executable instructions for implementing logical functions. A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; and/or (g) an appliance-based operating system, such as that implemented in handheld computers or personal data assistants (PDAs) (e.g., PalmOS® available from Palm® Computing, Inc., and Windows CE® available from Microsoft® Corporation). The operating system 286 can be configured to control the execution of other computer programs and provides scheduling, input-output control, file and data management, memory management, and communication control and related services.

A system component embodied as software may also be construed as a source program, executable program (object code), script, and/or any other entity comprising a set of instructions to be performed. When constructed as a source program, the program is translated via a compiler, assembler, interpreter, or the like, which may or may not be included within the volatile and nonvolatile memory 284, so as to operate properly in connection with the Operating System 286.

The Input/Output devices that may be coupled to system I/O Interface(s) 296 may include input devices, for example but not limited to, a keyboard, mouse, scanner, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

If the client device 102 is a personal computer, workstation, or the like, the software in the volatile and nonvolatile memory 284 may further include a basic input output system (BIOS) (omitted for simplicity). The BIOS is a set of software routines that initialize and test hardware at startup, start the Operating System 286, and support the transfer of data among the hardware devices. The BIOS is stored in ROM so that the BIOS can be executed when the client device 102 is activated. When the client device 102 is in operation, the processor 282 may be configured to execute software stored within the volatile and nonvolatile memory 284, to communicate data to and from the volatile and nonvolatile memory 284, and to generally control operations of the client device 102 pursuant to the software. Software in memory, in whole or in part, are read by the processor 282, perhaps buffered within the processor 282, and then executed.

FIG. 3 is a screenshot diagram illustrating an exemplary user interface illustrating a search engine display, such as a search engine display that may be provided by the search engine server from FIG. 1. More specifically, the nonlimiting example of FIG. 3 includes a web browser user interface display 360, displaying a search engine web page associated with www.searchthisforme.com. In the user prompt 362, a user has entered the search criteria “Beatles” and selected the search option 364. Upon executing the search, the search engine has provided a plurality of links to web pages associated with the entered search criteria. As a nonlimiting example, in response to the search term “Beatles,” the search engine found the web pages www.thebeatlesarethebest.com 366, www.thebeatlesarethebest.com/memorabilia 368, www.beatlesinjapan.com 370, as well as others. As discussed above, oftentimes these web pages are displayed irrespective of the perceived relevance of the search, irrespective of the association among results, and/or irrespective of whether the user has previously viewed one or more of the results.

FIG. 4 is a screenshot diagram illustrating an exemplary user interface for a website that may be revealed by a search using the search engine display from FIG. 3. More specifically, the user interface display 460 is associated with the web address www.beatlesinjapan.com. As one of ordinary skill in the art will understand, although this web page refers to the search term “beatles,” the user may have actually desired to search the term “beetles.” In such a scenario, the user may desire to return to the search engine web page (FIG. 3) to revise the search terms.

FIG. 5 is a screenshot diagram illustrating an exemplary user interface configured to display the search results from FIG. 3, further illustrating a previously selected result. More specifically, the user interface display 560 includes the search engine web page with the revised search terms “Japanese” and “beetles.” Upon selecting the search option, the search engine can search the web and return data associated with Japanese beetles. The search results may include the web page associated with www.beatlesinjapan.com 562, which has been previously viewed by the user. Despite an indication that the user has previously viewed the web page associated with www.beatlesinjapan.com, the user is displayed this page.

FIG. 6 is a screenshot diagram of an exemplary user interface, illustrating the search engine from FIG. 3, further including filtering options. More specifically, in this nonlimiting example, user interface display 660 (and/or the search engine) can be equipped with one or more filter options to intelligently display results from a web search. As illustrated, the “filter duplicates” option 670 is selected. The “filter duplicates” option 670 can enable logic on the client device 102 (and/or search engine server 104) to reorganize the received results. As a nonlimiting example, such duplicate and/or related web pages can be removed from view of the user (permanently or temporarily), the duplicate and/or related web pages can be organized such that the relationship of these results are known, or both.

Additionally included in the nonlimiting example of FIG. 6 is a “filter previously viewed” option 672. The “filter previously viewed” option 672 can be configured to enable logic associated with the client device 102 and/or search engine server 104 to reorganize those results that have been previously selected by the user. Similar to the “filter duplicates” option 670, the “filter previously viewed” option 672 can be configured to display the previously viewed results in a predetermined position (e.g., at the end of the results, in a separate folder, all together, etc.), and/or delete the previously viewed results altogether.

FIG. 7 is a screenshot diagram of an exemplary user interface, illustrating the search engine display from FIG. 3, further including a “search again option.” More specifically, referring back to the nonlimiting example of FIG. 6, a user has previously searched the term “beatles.” The user has selected the web page www.beatlesinjapan.com, which does not appear to include information related to the user's desired search. The user then returns to the user interface display 760 in FIG. 7 and changes the search criteria from “beatles” to “Japanese” and “beetles.” The user can additionally select the “filter previously viewed” option 772 (and/or the “filter duplicates” option 770), and select the “search again” option 762. The search engine can then perform another search for the new search criteria. The search engine can then send the results to the client device 102. The client device 102 can compare the received results with previously viewed results (and recently selected links) to determine whether one or more the new results have been previously viewed. If the client device 102 determines that one or more of the new results have been previously viewed, the client device 102 can remove and/or rearrange the previously viewed results, as discussed above. Additionally, if the user wishes to conduct a new search (e.g., not include previous searches in determining the results to display), the user can select the “new search” option 764.

By selecting the “new search” option 764, data related to previous searches can be erased and/or not utilized in performing subsequent searches.

Additionally included in the nonlimiting example of FIG. 7 are “show me all from this source” options 774a and 774b. More specifically, upon viewing the web page www.keepthebeetlesoff.com (by selecting and/or simply viewing the search results), the user can determine that the desired information is likely on this page or a page related to this website. The user can then select “show me all from this source” option 774b. Depending on the particular configuration, the previously displayed results can be reconfigured such that only those results that are related to the www.keepthebeetlesoff.com website are displayed. These results can be displayed in an expandable configuration as illustrated in FIG. 10, however this is not a requirement. In other embodiments, upon selecting the “show me all from this source” option 774, the search engine can conduct another search, directed only toward the selected website (or websites).

Additionally, upon selecting the “show me all from this source” option 774, the user can further refine the search within this source. More specifically, by including additional (and/or different) search criteria and selecting the “show me all from this source” option 774, the user can search the source for the refined search criteria, thereby further increasing the search capabilities within a particular source.

FIG. 8 is a screenshot diagram of an exemplary user interface, illustrating the search engine display from FIG. 3, further including a “don't show me this again” option 866a-866c. More specifically, the user interface display 860 includes a “search again” option 862, a “new search” option 864, a “filter duplicates” option 870, and a “filter previously viewed” option 872. Additionally, included in the nonlimiting example of FIG. 8 are “don't show me this again” options 866a-866c. The “don't show me this again” options 866 can provide the user with the ability to, upon viewing the search results (and not necessarily selecting to view the web page), remove that result from the current string of searches. As a nonlimiting example, upon viewing the results on user interface display 860, the user may determine that www.beatlesinjapan.com is not relevant to the current search. The user can then select the “don't show me this again” option 866a. The user interface display 860 can then be amended such that, during the current string of searches, this web page (and/or website, depending on the configuration) is no longer visible. As discussed above with other options, the undesirable result(s) may be removed and/or reorganized such that the result(s) do not interfere with the visibility of the other, more relevant results.

FIG. 9 is a screenshot diagram of an exemplary user interface, illustrating the search engine display from FIG. 3, further including a trunk expansion option 968a-968c. More specifically, in at least one embodiment of user interface display 960, the received results can be organized according the website to which that particular result is related. As a nonlimiting example, in performing a search for the search terms “Japanese” and “beetles,” the search engine 104 can retrieve a plurality of results. In at least one embodiment, two or more of the results can be related via the same website. In such a configuration, the client device 102 can be configured to recognize those related results and configure the display 960 such that the most general result (referred to here as a “trunk”) of the related results is displayed. Additionally included is an “expand trunk” option 968a, 968b, and 968c. The “expand trunk” option 968 can be configured to display other related results to the displayed trunk result.

FIG. 10 is a screenshot diagram of an exemplary user interface, illustrating the search engine display from FIG. 3, further including a trunk collapse option. More specifically, in the nonlimiting example, “expand trunk” option 968a related to the wwwjapanesebeetlescovertheworld.com trunk has been selected. Upon selection of the “expand trunk” option 968a, related results are also displayed. As illustrated in FIG. 10, this includes the result www.japanesebeetlescovertheworld.com/species. As also illustrated, FIG. 10 includes a “collapse trunk” option 1074, which can remove from display the more specific results related to that trunk (e.g., www.japanesebeetlescovertheworld.com/species).

Additionally included in the user interface display 1060 are “don't show me this again” options 1066a, 1066b, and 1066c. As illustrated, these options can allow a user to remove a single result from display (e.g., by selecting 1066b) and/or remove a trunk and related results (e.g., by selecting 1066a and/or 1066c). More specifically, by selecting the “don't show me this again” option 1066b, the result related to the link www.japanesebeetlescovertheworld.com/species can be removed from the display, while other results from the wwwjapanesebeetlescovertheworld.com website can still be displayed (as well as other related web pages). By contrast, if the user selects “don't show me this again” option 1066a, the www.japanesebeetlescovertheworld.com web page and all other web pages related to this website (trunk) can be removed from this display. This provides the user with the ability to remove a single result and/or multiple results from a search.

Also included with user interface 1060 is an “expand trunk” option 1068. A “search again” option 1062, as well as a “new search” option 1064 are also included and can be configured to provide search options as described above. A “filter duplicates” option 1070 and a “filter previously viewed” option 1072 may also be provided for filtering search results, as described above.

FIG. 11 is a screenshot diagram of an exemplary user interface, illustrating the search engine display from FIG. 3, further including an embodiment for utilization of a context based searching. More specifically, in the nonlimiting example of FIG. 11, a user has performed a search for the search term “bat.” As discussed above, the search engine server 104 locates various results that include the search term. In this nonlimiting example, the search engine 104 found a plurality of results, two of which are displayed in user interface display 1160. The first result 1163 displayed is associated with the address www.batsarehelpful.com and appears to discuss the term “bat” as referring to the mammal. The second result 1162 displayed is associated with the address www.buyyourbaseballbatshere.com and appears to discuss the term “bat” as referring to athletic equipment. As the two results have different usages for the term “bat,” it is unlikely that the user will find both results helpful in this particular search.

FIG. 12 is a screenshot diagram of an exemplary user interface of the search engine display from FIG. 3, further including a user option to select from a plurality of contexts. More specifically, the client device 102 (and/or the search engine server 104) can be configured to determine (via a linguistic determination algorithm and/or other techniques) the context used for the search term(s) in a search. As illustrated in this nonlimiting example, the client device 102 can separate those results that use the term “bat” in the context of a mammal from those that use the term “bat” in the context of athletic equipment. User interface display 1260 includes a context title 1262a referring to mammals and a context title 1262b referring to athletic equipment. Under these context titles are results that use the term “bat” in that particular context. Additionally included are “select this context” options 1264a and 1264b which can be configured to focus the search on those results that can be classified within that context. More specifically, by selecting the “select this contest” option 1264a, the client device 102 (and/or search engine server 104) can reconfigure the results such that only results that discuss “bat” in the context of the mammal are shown. Similarly, by selecting the “select this context” option 1264b, only those results that discuss “bat” in the context of athletic equipment may be displayed.

One should note that although the contexts displayed in FIG. 12 relate to the characterizations of the search term “bat” into discrete categories of “mammal” and “athletic equipment,” this is a nonlimiting example. As one of ordinary skill in the art will understand, the context “mammal” need not include the term “mammal,” but instead may be categorized according to any of a plurality of different terms and/or syntax. Additionally, it is conceivable that various contexts can overlap such that one or more results can be categorized into a plurality of contexts. In such a scenario, the results may be displayed in each context, in one context, and/or in another configuration.

FIG. 13 is a flowchart illustrating exemplary steps that can be taken by a web browser in searching for web pages from the search engine display from FIG. 3. The first step in the nonlimiting example of FIG. 13 is for a web browser to receive search criteria from a user (block 1330). The web browser can be displaying a search engine display, however this is not a requirement. In at least one embodiment, the web browser can include a “toolbar” that includes a user prompt for a search engine.

Next, the web browser sends a search request to the search engine server 104 (block 1332). The search request may include the search criteria, as well as other data. The web browser can then receive and display results of the search from the search engine server 104 (block 1334). The browser can then receive an indication to view at least one of the results received from the search engine server (block 1336). The web browser can then send a request for redirect to a selected result (block 1338). The web browser can then receive data for the redirect (block 1340).

More specifically, the user may select one (or more) of the received results. The web browser can send a request, to the search engine server 104 to view that result. The search engine server 104 can then redirect the user's client device 102 to the desired result. The web browser can then determine whether there is another search (block 1342). If there is another search, the web browser returns to receiving the search criteria (block 1330). If there is not another search, the process may end.

FIG. 14 is a flowchart illustrating exemplary steps that can be taken by a server such as the server from FIG. 1 in searching for web pages. The first step in this nonlimiting example is for the server to receive a request for a search engine page (block 1430). Next, the search engine server 104 can provide the search engine source code for a web browser to interpret (block 1432). The server 104 can then receive at least one search term related to a desired search (block 1434).

Upon receiving the at least one search term, the search engine server 104 can locate (via a web crawl or other technique for locating web pages) and send results associated with the received at least one search term (block 1436). The server 104 can then receive an indication to view at least one result (block 1438). The server 104 can then send redirect data associated with the selected result (block 1440). The server 104 can then determine whether there is a new search (block 1442). If there is a new search, the server 104 can return to block 1430 to receive a request for a search engine page. If, on the other hand, there is not a new search, the process can end.

FIG. 15A is a flowchart illustrating exemplary steps that can be taken by a web browser in displaying unviewed search results, similar to the flowchart from FIG. 14. The first step in this nonlimiting example is for a client device 102 to receive search criteria from a user (block 1530). Next, the client device 102 can send a search request, which may include the search criteria, to a search engine server 104 (block 1532). The client device 102 can then receive results from the server 104 (block 1534).

The client device 102 can then receive an indication for the user to view at least one of the received results (block 1536). The client device 102 can send a request for redirect to the indicated result (block 1538). The client device 102 can then store data related to the selected result (block 1540). Next, the client device 102 can receive data for a redirect (block 1542). The client device 102 can then determine whether the user desires to perform a new search (block 1544). If the user desires a new search, the process can return to block 1530 to receive search criteria. If, on the other hand, the client device 102 determines that a new search is not desired, the flowchart can proceed to jump block 1546, which leads to FIG. 15B.

FIG. 15B is a continuation of the flowchart from FIG. 15A. More specifically, from jump block 1548, the process proceeds to determine whether the user desires to search again (block 1550). As illustrated in FIG. 7, the user can determine whether to “search again” and include a previous line of searching for intelligent organization of results. If the user does not desire to search again, the process can end, but if the user desires to search again, the client device 102 can receive new search criteria from the user (block 1552). The client device can then send a new search request to the server (block 1554). The new search request can include new search criteria, previously searched search criteria, and/or other data.

Upon sending the search request, the client device 102 can receive new search results associated with the current search (block 1556), and can compare the new search results with the previously stored search results (block 1558). The client device 102 can then remove the search results from the current search that have been viewed (block 1560). The client device 102 can then display the remaining search results (block 1562).

FIG. 16A is a flowchart illustrating exemplary steps that can be taken by a server in displaying unviewed results, similar to the flowcharts from FIGS. 15A and 15B. The first step in this nonlimiting example is for the search engine server 104 to receive a request for source code including a client identifier (block 1630). More specifically, a user may make a request on a client device 102 for a search engine display. In making the request, the client device 102 may include an identifier (e.g., a cookie and/or other data for identifying the source of the request) with the request. The server, upon receiving the identifier, can determine whether the client (and/or user) has made any previous searches that may be relevant to the current search.

Upon receiving the request, the server 104 can send source code related to the search engine user interface (block 1632). The server 104 can then receive search criteria for performing a search from the user (block 1634). The server 104 can search for and retrieve results corresponding to received search criteria (block 1636). Upon retrieving data related to the search criteria, the server 104 can send the retrieved search results to the client device 102 (block 1638). The server 104 can then receive a request from the user to view at least one result (block 1640). The server 104 can store data related to the requested result (block 1642) and send data related to the requested result to the client device 102 (block 1644). The server 104 can then determine whether the user desires a new search (block 1646). If the user desires a new search, the flowchart returns to block 1630 to receive a new request for source code. If, on the other hand, the user does not desire a new search, the flowchart proceeds to jump block 1650, continued in FIG. 16B.

FIG. 16B is a continuation of the flowchart from FIG. 16A. More specifically, jump block 1652 proceeds to determination block 1654 to determine whether the user desires to search again. If the user does not desire to “search again,” the process can end. If, however, the user desires to search again, the server 104 can send source code related to the search engine user interface (block 1656). The server 104 can then receive new search criteria from the user (block 1658), which may include previously searched terms, although this is not a requirement. The server 104 can then search for and retrieve results based on the received search criteria (block 1660).

Upon retrieving the search results, the server 104 can compare the results of the current search with results stored in block 1642 (block 1662). The server 104 can then organize results according to those results that are present in the current search, as well as stored from a previous search (block 1664). The server 104 can then send the results to the client device 102 (block 1668). Next, the server 104 can receive a request to view at least one of the results (block 1670). The flowchart can then proceed to jump block 1672, continued in FIG. 16C.

FIG. 16C is a continuation of the flowchart from FIG. 16B. More specifically, from jump block 1674, the flowchart proceeds to process block 1676, where the server 104 can store the requested result. The server 104 can then send data related to the requested result to the user (block 1678). The flowchart can then proceed to jump block 1680, which returns to jump block 1648 in FIG. 16A, where a determination is made as to whether the user desires a new search.

FIG. 17 is a flowchart illustrating exemplary steps that can be taken by a web browser in removing duplicates results from a search, similar to the flowchart from FIGS. 15A and 15B. The first step in this nonlimiting example is for the client device 102 to receive search criteria from a user (block 1730). The client device 102 can then send a search request to a search engine server 104 (block 1732). The client device 102 can then receive search results from the server 104 (block 1734), and compare each search result to determine whether any of the results are duplicates of other search results (block 1736).

Upon determining whether there are any duplicates results, the client device 102 can remove those duplicates (block 1738). The client device 102 can then display remaining results (block 1740). The client device 102 may receive an indication of a selected result (block 1742) and send a request for the selected result to the server (block 1744).

FIG. 18 is a flowchart illustrating exemplary steps that can be taken by a server in removing duplicate results from a search, similar to the flowchart from FIGS. 16A, 16B, and 16C. The first step in this nonlimiting example is for the server 104 to receive a request for source code including a client identifier (block 1830). Next, the server 104 can send the source code for display (block 1832). Upon sending the source code, the server 104 can receive search criteria related to a user search (block 1834). The server 104 can then search for and retrieve results corresponding to the received search criteria (block 1836). The server 104 can then determine whether any of the results are duplicates of other results (block 1838). The server can organize the results according to the duplicates identified (block 1840). The server 104 can then receive a request to view at least one result (block 1842). The server 104 can then send data related to the requested result (block 1844).

FIG. 19 is a flowchart illustrating exemplary steps that can be taken by a web browser in determining related results from a search, similar to the flowchart from FIG. 16. The first step in this nonlimiting example is for the client device 102 to receive search engine source code from a search engine server 104 (block 1930). Next, the client device 102 can display an interface associated with the search engine (block 1932). Next, the client device 102 can receive search criteria from the user (block 1934). The client device 102 can then send a search request to the search engine server 104 (block 1936).

The client device 102 can then receive results for the search from the search engine server 104 (block 1938). The client device 102 can then determine those results in the search with related addresses, as well as which results of each family is the “trunk” result (block 1940). The client device 102 can then display the trunk result with the ability to expand and/or collapse the related results, as illustrated in FIGS. 9 and 10.

FIG. 20 is a flowchart illustrating exemplary steps that can be taken by a server in organizing related results, similar to the flowchart from FIG. 18. The first step in this nonlimiting example is for the server 104 to receive source code for a search engine interface as well as a client identifier (block 2030). Next, the server 104 can send the requested source code to the client (block 2032). The server 104 can then receive search criteria associated with a desired search (block 2034). The server 104 may perform the search and retrieve pertinent results for the received search criteria (block 2036). The server 104 can then determine a relationship among the retrieved results, including determining whether any of the results can be classified as a “trunk” result (block 2038). The server 104 may then organize the results such that the determined trunks are displayed with user options to view other related results upon subsequent user input (block 2040). The server 104 can then send the organized search results (block 2042).

FIG. 21 is a flowchart illustrating exemplary steps that can be taken by a web browser in providing context based searching, similar to the flowchart from FIG. 20. The first step in this nonlimiting example is for the client device 102 to receive search engine source code from a search engine server 104 (block 2130). The source code can be provided in response to a user request for a search engine (e.g., typing an address associated with the search engine). Upon receiving the source code, the client device 102 can display an interface associated with the search engine (block 2132). The client device 102 can then receive search criteria from the user (block 2134). The client device can send a search request to the server, based on the received search criteria (block 2136).

The client device 102 may then receive results of the search from the server 104 (block 2138). Upon receiving the results, the client device 102 can determine the linguistic structure of the search terms in the search results to determine the contextual usage of the terms (block 2140). The client device 102 can then organize the results based on the determined contextual usage (block 2142).

FIG. 22 is a flowchart illustrating exemplary steps that can be taken by a server in providing context based searching, similar to the flowchart from FIG. 21. The first step in this nonlimiting example is for the server 104 to receive a request for source code, where the request includes a client identifier (block 2230). The server 104 can then send the requested source code to the client (block 2232). Upon sending the source code, the server 104 can receive a search request from the client (block 2234). The server can then perform a search based on the received search criteria and retrieve pertinent results (block 2236).

Next, the server 104 can determine the linguistic context of the retrieved results (block 2238). Based on the determined context, the server 104 can organize the results according to context (block 2240), and send the organized results to the client device 102 (block 2242)

The embodiments disclosed herein can be implemented in hardware, software, firmware, or a combination thereof At least one embodiment disclosed herein may be implemented in software and/or firmware that is stored in a memory and that is executed by a suitable instruction execution system. If implemented in hardware, one or more of the embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for displaying search results, the method comprising:
receiving search results related to a first requested search;
requesting access to at least one of the received results;
storing data related to the requested at least one result;
receiving search results related to a second requested search;
determining whether at least one of the search results related to the second requested search matches at least a portion of the stored data related to the requested at least one result; and
in response to determining that at least one of the search results related to the second search matches at least a portion of the stored data related to the requested at least one result, displaying a subset of the search results related to the second requested search.

2. The method of claim 1, further comprising:
determining whether at least two of the search results related to the second search are identical; and
in response to determining that at least two of the search results related to the search are identical, removing at least one of the identical results from the display.

3. The method of claim 1, further comprising determining whether at least two of the search results related to the second search are related.

4. The method of claim 3, further comprising organizing the related search results.

5. The method of claim 1, further comprising determining a context related to at least one of the results related to the second search.

6. The method of claim 1, wherein displaying a subset of the search results related to the second requested search includes removing at least one previously viewed result from the search results related to the second requested search.

7. The method of claim 1, further comprising providing a user option to prevent at least one search result from being displayed.

8. A computer readable medium for displaying search results, the computer readable medium comprising:
logic configured to receive search results related to a first requested search;
logic configured to request access to at least one of the received results;
logic configured to store data related to the requested at least one result;
logic configured to receive search results related to a second requested search;
logic configured to determine whether at least one of the search results related to the second requested search matches at least a portion of the stored data related to the requested at least one result; and
logic configured to, in response to determining that at least one of the search results related to the second search matches at least a portion of the stored data related to the requested at least one result, display a subset of the search results related to the second requested search.

9. The computer readable medium of claim 8, further comprising:
logic configured to determine whether at least two of the search results related to the second search are identical; and
logic configured to, in response to determining that at least two of the search results related to the search are identical, remove at least one of the identical results from the display.

10. The computer readable medium of claim 8, further comprising logic configured to determine whether at least two of the search results related to the second search are related.

11. The computer readable medium of claim 8, further comprising logic configured to organize the related search results.

12. The computer readable medium of claim 8, further comprising logic configured to determine a context related to at least one of the results related to the second search.

13. The computer readable medium of claim 8, wherein the logic configured to display a subset of the search results related to the second requested search includes logic configured to remove at least one previously viewed result from the search results related to the second requested search.

14. The computer readable medium of claim 8, further comprising logic configured to provide a user option to prevent at least one search result from being displayed.

15. A system for filtering search results, comprising:
a receiving module configured to receive a plurality of search results;
a determination module configured to determine whether at least one of the results has been previously selected; and
a display module configured to display the plurality of results without the at least one previously selected result.

16. The system of claim 15, further comprising a comparison module configured to compare each of the plurality of received results to determine whether any results are duplicates.

17. The system of claim 15, wherein the comparison module is further configured to remove duplicate results from the received results.

18. The system of claim 15, further comprising a context module configured to determine a context related to at least one of the received results.

19. The system of claim 15, further comprising a relation module configured to determine whether any of the received results are related.

20. The system of claim 19, wherein the relation module is further configured to determine a relational hierarchy for a plurality of related results.
